(19) United States
(12) Patent Application Publication
(10) Pub. No.: US 2002/0127374 A1
(43) Pub. Date: Sep. 12, 2002

(54) Adhesive materials for flooring and methods of using same

(76) Inventor: Michael Spratling, Cartersville, GA (US)

Correspondence Address: John S. Pratt, KILPATRICK STOCKTON LLP, Suite 2800, 1100 Peachtree Street, Atlanta, GA, 30309-4530, US

(21) Appl. No.: 09/969,499

(22) Filed: Oct. 2, 2001

Related U.S. Application Data
(60) Provisional application No. 60/237,141, filed on Oct. 2, 2000.

(51) Int. Cl. B32B 23/02

(52) U.S. Cl. 428/192; 428/321.5

(57) ABSTRACT

Novel adhesive materials and methods of using the same that are highly effective at securing flooring materials. The adhesive materials are used to secure flooring materials together. Additionally, the present invention is directed to methods of securing floor materials using the adhesive materials of the present invention. The present invention uses a adhesive material that is microencapsulated and then applied to the edge of the flooring material as part of dried medium. When the individual pieces of flooring material are placed into position, the microcapsules rupture, thereby releasing the adhesive. The adhesive then secures the edges of each individual piece to one another. Additionally, means may be used to aid in the rupture of the microcapsules to ensure the desired attachment of the flooring materials.

### FIELD OF THE INVENTION

The present invention is directed to adhesive materials and methods of using the same. In particular, the present invention is directed to adhesive materials that are microencapsulated and used to secure flooring materials together. Additionally, the present invention is directed to methods of securing floor materials using the adhesive materials of the present invention.

### BACKGROUND OF THE INVENTION

In almost every home and commercial environment, the floors of these environments have some type of floor covering, such as carpeting or tile. These floor coverings include commercial and residential carpeting, carpet tiles, sheet vinyl and vinyl composition tiles (VCTs). These floor coverings serve several purposes. Many are used for decorative purposes or to provide a comforting effect in the home or office. Some floor coverings are used for safety purposes, such as to provide traction. Finally, some floor coverings, mainly tile, are selected for their ability to be easily cleaned.

While some of these floor coverings are attached in some manner to the underlying surface, depending upon the type of flooring material, these materials may also be attached to one another. For example, ceramic tile, brick, and wood flooring usually comprise pieces that are attached to one another. While these materials may also be attached to the underlying surface, it is important that they be attached to one another as well to ensure that individual pieces do not come loose, thereby endangering individuals using the flooring.

Currently, floor materials may be secured to one another using some type of fastening means, such as nails or screws, or may be glued or caulked to one another using a liquid adhesive or a caulking agent. However, there are difficulties associated with these different means.

The use of fastening means, such as nails or screws, require a great deal of labor intensive work usually involving a worker bending over the materials to secure them. This process may be tedious and painful to the worker. Additionally, if the fastening means is not caused to be flush with the flooring, potential dangers may arise from the protruding fastening means including snagging of clothing or abrasion of skin.

Liquid adhesives or caulking agents may be used to alleviate the problems caused by fastening means. However, these agents also present some problems as well. Since flooring materials are usually bundled together when shipped, the liquid adhesive or caulking agent must be applied immediately prior to installation of the flooring material. Accordingly, the application of the adhesive or agent is an additional labor step that increases the length of time needed to install the flooring. Additionally, these adhesives and agents may be difficult to apply evenly, thereby presenting potential problems if insufficient amounts are used wherein pieces of the flooring may come loose. Finally, these agents are messy to deal with and present unique cleaning problems after the flooring has been installed.

Accordingly, there is need to provide a means and method for installing flooring materials that may be used to secure flooring in a fast and effective manner. Additionally, what is needed is a means and method for securing flooring materials that may be done prior to installation of the flooring material, thereby making the installation of the flooring much easier. Finally, what is needed is a means and method for installing flooring materials that eliminates the need to use messy liquid adhesives and/or caulking agents.

### SUMMARY OF THE INVENTION

The present invention is directed to adhesive materials and methods of using the same. In particular, the present invention is directed to adhesive materials that are microencapsulated and used to secure flooring materials together. Additionally, the present invention is directed to methods of securing floor materials using the adhesive materials of the present invention.

The present invention uses adhesive materials that are microencapsulated and applied to at least a portion of a side edge of a flooring material. Since the microencapsulated adhesives are dry to the touch and part of a dried medium, the adhesives may be applied prior to packaging and shipment of the flooring material. The adhesive materials are selected such that when the flooring is installed and the microcapsules are ruptured, the adhesive material that is released is capable of securing one piece of flooring to another without the need manually apply liquid adhesives or caulking agents during installation of the flooring.

Additionally, the adhesive materials may be used in methods to secure floor materials that are installed on an underlying surface. The adhesive materials are microencapsulated and then coated onto at least a portion of a side edge of the flooring material. Then, as the flooring materials are placed next to one another, the microcapsules are caused to rupture, thereby securing one piece of flooring to another. This allows the flooring materials to be installed quickly and securely, without the hassles associated with liquid adhesives or caulking agents.

Accordingly, it is an object of the present invention to provide an adhesive material that is useful at securing flooring materials together.

It is another object of the present invention to provide an adhesive material that is useful at securing flooring materials together without the need for liquid adhesives or caulking agents.

It is still another object of the present invention to provide an adhesive material that is useful at securing flooring materials together that may be applied to the flooring material ex situ.

It is yet another object of the present invention to provide a method for securing flooring materials together.

It is still another object of the present invention to provide a method for securing flooring materials together in a fast, clean and easy manner.

The present invention satisfies one or more of the previous objects. Additionally, other objects, features and advantages of the present invention will become apparent after a review of the following detailed description of the disclosed embodiments and the appended claims.

### DETAILED DESCRIPTION

The present invention is directed to adhesive materials and methods of using the same. In particular, the present invention is directed to adhesive materials that are microencapsulated and applied to a material such that when the microcapsules are ruptured, the adhesive is released and the two or more materials may be secured to one another. Additionally, the present invention is directed to methods of securing two materials together using the adhesive materials of the present invention. The present invention is particularly useful for flooring materials and methods of securing flooring materials together.

The present invention comprises the use of adhesive materials that are microencapsulated into microcapsules. As used herein, “microencapsulated adhesive material” refers to a liquid or semi-solid adhesive material that is encapsulated into microcapsules wherein the microcapsules are constructed and arranged to rupture upon application of a rupturing force to release the adhesive material which then bonds two or more materials together. The microcapsules are generally of a size to permit application to a surface of a material such that normal handling of the material will not cause the microcapsules to break. Generally, the microcapsules are spherical in shape, though other shapes may be used. The microcapsules are selected such that a majority of the microcapsules are less than about 1000 microns (μm) in diameter. More desirably, the majority of the microcapsules are less than about 500 μm in diameter. Even more desirably, the majority of the microcapsules are less than about 100 μm in diameter. Even more desirably, the majority of the microcapsules are less than about 50 μm in diameter. The adhesive may be encapsulated using any known microencapsulating technique.

These microcapsules are then incorporated into a medium that is applied to at least a portion of a side edge of the material to be secured. Once in place, these microcapsules are substantially dry to the touch and have no adhesive properties. These characteristics permit the material having the microcapsules coated thereto to then be packaged and/or shipped in a ready-to-use state. When the materials are opened and used, the individual working with the materials may easily place each material into the desired location. When sufficient force is exerted in placement of the material, the microcapsules containing the adhesive material are caused to rupture. This rupturing releases the adhesive material that then bonds the side edge of the material to the side edge of the adjacent material. If the adjacent material also includes microencapsulated adhesive, these microcapsules would also rupture thereby providing a double bonding effect that ensures that the materials are properly secured.

Depending on the type of material involved, placement of one coated edge against the edge of the adjacent material may not sufficiently rupture the microcapsules. As such, additional means may be used to cause the rupture of the microcapsules. These means may include the use of a microwave transmitter or an ultrasonic transmitter that may be passed over the material after it has been placed in the desired position. The transmitter would be selected such that the energy released would be sufficient to cause the rupture of the microcapsules. Other types of energy transmitters may be used besides microwave or ultrasound as long as the energy transmitter was capable of causing the rupture of the microcapsules.

The present invention may be used with a variety of different materials, and especially flooring materials. Preferable materials that may be secured using the present invention include laminate flooring, hardwood flooring and manufactured wood flooring. Additionally, other types of flooring that may be secured include those having a joining profile, such as tongue-and-groove flooring or other joining profiles that serve to join the edges of the flooring. Finally, other flooring materials, such as ceramic tiles and brick flooring may also be used.

The type of adhesive that may be used in the present invention may vary depending on the type of flooring, the desired level of attachment, and the means by which the microcapsules will be ruptured. Typically, the adhesive will be a single element adhesive, including, but not limited to, rubber cements, mastics, pressure sensitive adhesives, acrylics, vinyl acetates, ethylene vinyl acetates, vinyl acrylics, styrene monomers and copolymers, neoprene latexes, nitrile latexes, SBR, or natural rubber latexes. Additionally, adhesives which have been fortified with terpenes, terpene phenolics, rosen esters and other tactifying additives may also be used. Combinations of these adhesives may also be used.

Two component urethanes and epoxies may also be used and these two component adhesives present additional opportunities. For example, one part of a two-part adhesive may be microencapsulated and applied to one edge of a first flooring material. The second part of the two-part adhesive would then be microencapsulated and applied to one edge of a second flooring material. Then, when the edge of the first flooring material is contacted with the edge of the second flooring material and the respective microcapsules are ruptured, the two parts of the adhesive contact one another causing bonding of the first and second flooring materials to one another. This type of system is especially useful in situations where proper placement of the material is desired, such as for patterned flooring materials or flooring materials having a unique side edge. An example of the latter would be a flooring material that utilizes a tongue-and-groove system for attaching one piece of flooring to another. The tongue portion of each piece may be coated with microcapsules containing one part of the two-part adhesive while the groove portion would contain the second part of the two-part adhesive. Then, when the tongue was inserted into the groove, the respective microcapsules would rupture thereby releasing both parts of the two-part adhesive further securing the two pieces together.

Additionally, different colors of mediums, such as a paint or powder, may be used such that one part of the adhesive is contained within one color of medium and the other part is contained in the second color of medium. Then, the person installing the flooring can match the two colors together to ensure the proper adhesive attachment. Different colors may also be used for other purposes, such as color coordinating to permit two or more different adhesives to be used to obtain any different benefits in the adhesives.

The present invention includes a material, such as a flooring material, having the adhesive material applied thereto. Once the adhesive has been microencapsulated, it is preferably applied to the material in a manner such that the coated area is substantially dry to the touch and wherein the microcapsules do not fall off prior to placement of the flooring material. As such, the microcapsules are preferably included in a medium that is then coated or applied to at least a portion of a side edge of the flooring material.

The medium in which the microcapsules may be included may vary depending on the desired final characteristics of the flooring product. Generally, however, any medium that is capable of being applied to an edge of the flooring material, that results in a coating that is substantially dry to the touch, and that secures the microcapsules to the edge of the flooring material may be used in the present invention. Media that may be used in the present invention include, but are not limited to, paints, stains, electrostatic powders, or combinations thereof.

The microcapsules are suspended in the desired medium and then applied to a side edge of the flooring material. The microcapsules and medium may be applied using any known coating technique, such as spray coating, or by directly applying the mixture, such as with a brush.

The adhesive materials are applied to the flooring materials in a manner such that when the flooring materials are placed and the microcapsules ruptured, the adhesive is released and secures the flooring pieces to one another. To achieve this result, the microcapsules are applied to the edge of the flooring. The microcapsules may be applied to the entire side edge of the material, or to only a portion of the edge, depending on the desired use. For example, microcapsules may be coated only on two sides of a square flooring material while the other two sides remain uncoated. Then, as the flooring materials are installed, the two coated sides of one piece are arranged to contact the uncoated sides of adjacent pieces. Then, even though each piece has only two coated sides, each piece will be secured to the adjacent pieces on all sides.

The present invention also includes methods of securing floor materials together. Once each piece of flooring material has been coated on at least a portion of its side edge with a coating containing the microcapsules of adhesive material, the flooring is installed and the microcapsules are caused to rupture, thereby releasing the adhesive which secures the side edges of each piece to one another. As previously discussed, the microcapsules may be ruptured using either manual force alone or may include the use of additional means, such as a microwave transmitter or an ultrasonic transmitter that is passed over the side edges to further enhance the rupturing of the microcapsules.

Additionally, the present invention may also be used in other areas not involving flooring materials. For example, the present invention may also be used with wall and decorative tiles. The adhesive material would be applied to at least a portion of the side edge of the tile. Then, as the tile was placed into position, the microcapsules would be ruptured, thereby securing the tiles to one another without the need for a messy caulking agent. As with the flooring materials, a microwave transmitter or ultrasonic transmitter may be used to aid in rupturing the microcapsules.

The present invention may also be used in the ready-to-assemble furniture industry wherein the microencapsulated adhesive is applied to the pieces during manufacture and wherein additional adhesive would not be needed when the furniture was assembled. The microencapsulated adhesive could be applied to either the pieces, the holes into which the pieces are inserted, or both. For example, for a chair or table, the chair table could be shipped as four legs and a seat or table top having four holes where the legs are inserted. Upon delivery, the chair or table could be assembled by inserting the legs into the holes. The portion of the legs inserted into the holes may have the microencapsulated adhesive. Or the holes themselves may have the microencapsulated adhesive coated therein. Or both the legs and the holes may include the microencapsulated adhesive and wherein two-part adhesives would be especially useful. The microencapsulated adhesive could be used with other ready-to-assemble furniture besides chairs and tables and would be applied to at least a portion of the surface area designed to be connected to another surface area of the piece of furniture.

As such, for ready-to-assemble furniture, the ready-to-assemble furniture should have at least a first piece of ready-to-assemble furniture having a surface area which is constructed and arranged to be secured to a second piece of ready-to-assemble furniture. The coating could be applied to at least a portion of the surface area of the first piece of ready-to-assemble furniture; to at least a portion of the surface area of the second piece of ready-to-assemble furniture; or both pieces.

Accordingly, the adhesive materials of the present invention have the ability to secure flooring materials together. The adhesive materials are used secure these flooring materials together in a fast and easy manner. Additionally, since the adhesive materials eliminate the need for liquid adhesives, the adhesive materials may be used in methods of securing floor materials that are faster and cleaner than traditional methods.

1. A flooring material comprising:
a flooring material having a side edge; and
a coating applied to at least a portion of the side edge;
wherein the coating comprises a microencapsulated adhesive material.

2. The flooring material of claim 1, wherein the coating is applied to substantially all of the side edge.

3. The flooring material of claim 1, wherein the adhesive material is selected from rubber cements, mastics, pressure sensitive adhesives, acrylics, vinyl acetates, ethylene vinyl acetates, vinyl acrylics, styrene monomers and copolymers, neoprene latexes, nitrile latexes, SBR, natural rubber latexes, adhesives that have been fortified with terpenes, terpene phenolics, or rosen esters, or combinations thereof.

4. The flooring material of claim 1, wherein the adhesive material is a two-part adhesive.

5. The flooring material of claim 4, wherein one part of the two part adhesive is located on at least a portion of a side edge of a first flooring material and a second part of the two part adhesive is located on at least a portion of a side edge of a second flooring material.

6. The flooring material of claim 1, wherein the microencapsulated adhesive material is included in a medium selected from paints, stains, electrostatic powders, or combinations thereof.

7. The flooring material of claim 1, wherein the flooring material is selected from laminate flooring, hardwood flooring manufactured wood flooring, tongue-and-groove flooring, locking profile flooring, ceramic tiles or brick flooring.

8. A tile material comprising:
a tile material having a side edge; and
a coating applied to at least a portion of the side edge;
wherein the coating comprises a microencapsulated adhesive material.

9. The tile material of claim 8, wherein the coating is applied to substantially all of the side edge.

10. The tile material of claim 8, wherein the adhesive material is selected from rubber cements, mastics, pressure sensitive adhesives, acrylics, vinyl acetates, ethylene vinyl acetates, vinyl acrylics, styrene monomers and copolymers, neoprene latexes, nitrile latexes, SBR, natural rubber latexes, adhesives that have been fortified with terpenes, terpene phenolics, or rosen esters, or combinations thereof.

11. The tile material of claim 8, wherein the adhesive material is a two-part adhesive.

12. The tile material of claim 11, wherein one part of the two part adhesive is located on at least a portion of a side edge of a first flooring material and a second part of the two part adhesive is located on at least a portion of a side edge of a second flooring material.

13. The tile material of claim 8, wherein the microencapsulated adhesive material is included in a medium selected from paints, stains, electrostatic powders, or combinations thereof.

14. A ready-to-assemble furniture comprising:
a first piece of ready-to-assemble furniture having a surface area constructed and arranged to be secured to a second piece of ready-to-assemble furniture; and
a coating applied to at least a portion of the surface area of the first piece of ready-to-assemble furniture;
wherein the coating comprises a microencapsulated adhesive material.

15. The ready-to-assemble furniture of claim 14, further comprising a coating comprising a microencapsulated adhesive material applied to at least a portion of the surface area of the second piece of ready-to-assemble furniture.

16. The ready-to-assemble furniture of claim 14, wherein the adhesive material is selected from rubber cements, mastics, pressure sensitive adhesives, acrylics, vinyl acetates, ethylene vinyl acetates, vinyl acrylics, styrene monomers and copolymers, neoprene latexes, nitrile latexes, SBR, natural rubber latexes, adhesives that have been fortified with terpenes, terpene phenolics, or rosen esters, or combinations thereof.

17. The ready-to-assemble furniture of claim 14, wherein the microencapsulated adhesive material is included in a medium selected from paints, stains, electrostatic powders, or combinations thereof.

18. A method of securing flooring materials together comprising:
applying a coating comprising a microencapsulated adhesive material to at least a portion of a side edge of a first flooring material;
contacting the side edge of the first flooring material with a side edge of a second flooring material; and
causing the microencapsulated adhesive material to rupture such that when the side edge of the first flooring material contacts the side edge of the second flooring material, the adhesive material secures the first flooring material to the second flooring material.

19. The method of claim 18, wherein the adhesive material is selected from rubber cements, mastics, pressure sensitive adhesives, acrylics, vinyl acetates, ethylene vinyl acetates, vinyl acrylics, styrene monomers and copolymers, neoprene latexes, nitrile latexes, SBR, natural rubber latexes, adhesives that have been fortified with terpenes, terpene phenolics, or rosen esters, or combinations thereof.

20. The method of claim 18, wherein the adhesive material is a two-part adhesive.

21. The method of claim 20, wherein one part of the two part adhesive is located on at least a portion of a side edge of a first flooring material and a second part of the two part adhesive is located on at least a portion of a side edge of a second flooring material.

22. The method of claim 18, wherein the microencapsulated adhesive material is included in a medium selected from paints, stains, electrostatic powders, or combinations thereof.

23. The method of claim 18, wherein microencapsulated adhesive material is caused to rupture through manual force.

24. The method of claim 18, wherein microencapsulated adhesive material is caused to rupture through the application of a rupturing force selected from a microwave transmitter or an ultrasonic transmitter.
